(19) United States
(12) Patent Application Publication
(10) Pub. No.: US 2012/0025702 A1
(43) Pub. Date: Feb. 2, 2012

(54) ELECTRICAL LAMP HAVING SEAL AND METHOD FOR PRODUCTION

(75) Inventor: Markus Stange, Berlin (DE)

(73) Assignee: OSRAM GESELLSCHAFT MIT BESCHRAENKTER HAFTUNG, Muenchen (DE)

(21) Appl. No.: 13/254,489

(22) PCT Filed: Feb. 18, 2010
(86) PCT No.: PCT/EP2010/052052

§ 371 Date: Sep. 2, 2011

(30) Foreign Application Priority Data
Mar. 3, 2009 (DE) 10 2009 011 525.0

(51) Int. Cl. H01J 61/30; H01J 9/32

(52) U.S. Cl. 313/634; 445/26

(57) ABSTRACT

An electrical lamp may include a bulb made of glass which surrounds a volume; illumination means extending into the volume and a filling being accommodated in the volume; the illumination means being fastened at least by means of a supply line in the wall of the bulb and being sealed there; wherein at least one part of the axial length of the supply line is surrounded inside the wall by a prevention structure, which is present in the glass itself.

### TECHNICAL FIELD

The invention is based on an electrical lamp according to the preamble of claim 1. Such lamps are, in particular, high-pressure discharge lamps with a glass vessel or even halogen incandescent lamps. In particular, they are suitable for general illumination, automobile illumination or photo-optical illumination. A further starting point is a production method for such a lamp.

### PRIOR ART

DE 20 2007 009 118U and DE-A 10 2005 013 759 disclose an electrical lamp in which the formation of damaging cracks in the glass is prevented by a structure being added to the current supply, which may be used as a starting point for stress relief cracks in the glass. As a result, micro-cracks are produced directly in the glass, preventing large cracks which lead to leakages.

Similar technical teaching is disclosed in EP-A 1065698. In this case, the entire foil region is specifically prepared in order to improve the seal.

### DESCRIPTION OF THE INVENTION

The object of the present invention is to provide an electrical lamp in which cracks in the glass are reliably avoided in a simple manner. A further object is to provide a production method for such a lamp.

This first object is achieved by the characterizing features of claim 1. The second object is achieved by the characterizing features of claim 8.

Particularly advantageous embodiments are set forth in the dependent claims.

A fundamental problem which occurs in all components which are internally embedded in glass is solved in the following manner:

As a result of the variable thermal coefficients of expansion cracks can be produced in the glass, in the event of temperature fluctuations, which may lead to the destruction of the glass body.

In many instances, therefore, it is a case of metals, often refractory metals, embedded in quartz glass. When embedded in glass, the glass is fused, molded around the component and cooled again. Below the solidification point (Tg), the glass is not able to follow the metal which shrinks to a greater extent during cooling, and to which it is connected. The metal thus causes stresses in the glass, the tensile stresses being relieved by fissures and cracks in the glass.

The stress relief cracks produced may either be avoided (A) or limited in their potential for damage (B), by attempts being made to produce a large number of cracks which are dispersed and thus smaller, which reduces the potential for general damage. Thus, the product is no longer destroyed by any size or shape of crack.

Examples of (A) are separating means between the metal and glass, known molybdenum rolls on tungsten electrode shafts or a type of ceramic stocking, see U.S. Pat. No. 5,107,177.

An example of (B) is a tungsten filament around a core pin in order to control the crack pattern, see DE-A 10 2004 057 906.

Using a suitably focused laser (for example an Nd:YAG laser) below Tg a structure of micro-cracks may be incorporated in the glass. Such micro-crack structures are known, for example from 3D images in glass blocks which are presented as gifts. Such a distribution of micro-cracks in the vicinity of the surfaces of the components embedded in the glass results in very consistent relief of the tensile stresses in the glass. If the density of the micro-cracks is very high, the component may be separated partially or even entirely from the surrounding glass mass. Thus it is also possible to locate the focus of the laser directly on the surface of the embedded component. The choice of micro-crack structure thus depends in each case entirely on the geometry of the embedded component and follows this geometry.

By means of the method according to the invention, no additional components are required for avoiding macroscopic cracks in the embedded glass. As a result, not only the costs thereof are eliminated and the processing is simplified, but potential sources of error are eliminated and additionally component geometries are obtained which may be separated from the glass, and which due to their shape cannot be achieved by additional separating components.

The lamp vessel typically consists of quartz glass or Vycor or a glass with relatively high SiO2 component or even hard glass as known from the prior art. The seal of the lamp vessel is either designed as a fused seal or pinch seal, no further details being provided here about the precise nature of the seal. Instead, it is important that the current supply system includes a pin or electrode shaft, which protrudes from the seal into the inside of the bulb. This is particularly critical for the seal. For this reason, a structure is used which prevents cracks in the glass in the region of said internal current supply which is referred to in general terms. The prevention structure surrounds the internal current supply, therefore, in the manner of a stocking. The prevention structure is, however, primarily produced in the glass itself. It is preferably produced as a disruptive center in the glass by means of laser bombardment. The structure consists of individual punctiform disruptive centers which have been produced by focusing the laser beam. The disruptive centers are thus preferably arranged in an intermittent structure in the vicinity of the internal current supply. Thus the spacing of the disruptive centers should be at a maximum of 500 μm from the internal current supply. The length of the structure should be at least 1 mm. Preferably, however, the structure is able to encompass a substantial part of the axial length of the internal current supply, in particular at least 50% of the length.

Preferably, the structure is a stocking-like array of disruptive centers which are uniformly arranged in lines and spaces around the internal current supply in a radial and axial manner. In particular, therefore, the spacing of the individual disruptive centers is approximately the same, both in the radial and the axial direction. The pattern of the disruptive centers may also be wound in the manner of a spiral around the internal current supply. The size of a disruptive center is preferably a maximum of approximately 0.1 mm. The maximum spacing between the disruptive centers should, in particular, be approximately 200 to 600 μm, but preferably it should not exceed 0.35 mm.

During production of the prevention structure, it is in principle possible to apply the disruptive centers both during and after the production of the seal. However, it is considerably more advantageous to produce the disruptive centers when, in the cooling phase during the production of the seal and at a temperature below Tg, the variable contractions of the materials have not yet produced any stresses in the glass which exceed the local material strength thereof. The temperature should, however, preferably still be above 100° C. In practice, a range of approximately 200 to 600° C. has proved advantageous for the cooling glass.

The production takes place by the pulsed action of a focused laser, for example of an Nd:YAG laser, the glass exhibiting low absorption for the wavelength thereof. On the other hand, a CO2 laser, for example, is not suitable.

### BRIEF DESCRIPTION OF THE DRAWINGS

The invention is to be described in more detail hereinafter with reference to a plurality of exemplary embodiments. In the figures:

FIG. 1 shows a discharge vessel for a high-pressure discharge lamp;

FIG. 2 shows a novel prevention structure in detail;

FIG. 3 shows a further exemplary embodiment of a novel prevention structure;

FIG. 4 shows a detailed view of a pinch seal region without a prevention structure as per the prior art;

FIG. 5 shows a detailed view of a pinch seal region with a filament as a prevention structure as per the prior art;

FIG. 6 shows a detailed view of a novel prevention structure in plan view (6a) and side view (6b);

FIG. 7 shows a detailed view of a further exemplary embodiment of a novel prevention structure;

FIG. 8 shows a detailed view of a further exemplary embodiment of a novel prevention structure.

### PREFERRED EMBODIMENT OF THE INVENTION

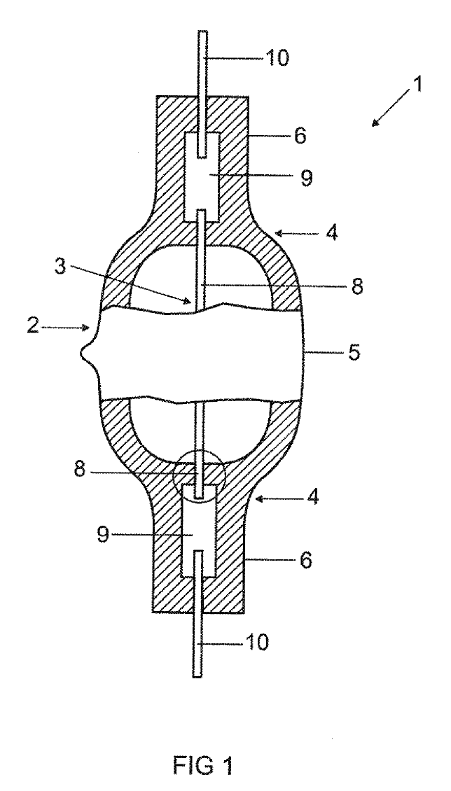

FIG. 1 shows schematically a discharge vessel 2 made of quartz glass for a metal halogen lamp 1, into which two electrodes 3 are inserted. The discharge vessel has a central part 5 and two ends 4. Two seals 6 are located at the ends which are designed as fused seals or pinch seals. Preferably, the discharge vessel and the seals are produced integrally from a material such as quartz glass.

The discharge vessel 2 may be surrounded by an external bulb on which a base is located, as known per se. A current supply system provides an electrical connection to the outside from an illumination means in the inside of the bulb, in this case two electrodes.

The current supply system consists of an internal current supply 8, a molybdenum foil 9 which achieves the actual seal as well as an external current supply 10.

Essential to the invention is in this case the region which is highlighted by a circle. In this case, the internal current supply 8 is regarded as the supply line.

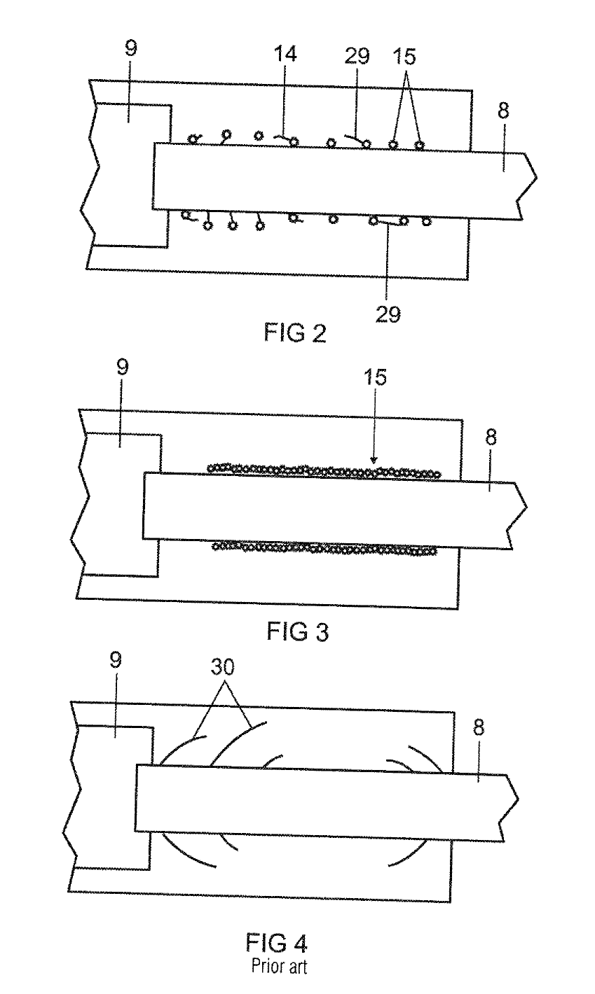

FIG. 2 shows a detail including the internal current supply 8. In this case, in the immediate vicinity of the internal current supply 8 disruptive centers 13 are formed in a uniform manner by laser bombardment from which micro-cracks 15 emerge. The axial distance thereof from the internal current supply is approximately 200 μm. The desired distance depends on the type of lamp and is a maximum of approximately 30% of the covering glass thickness. In particular, the disruptive centers should be as close as possible to the internal current supply 8.

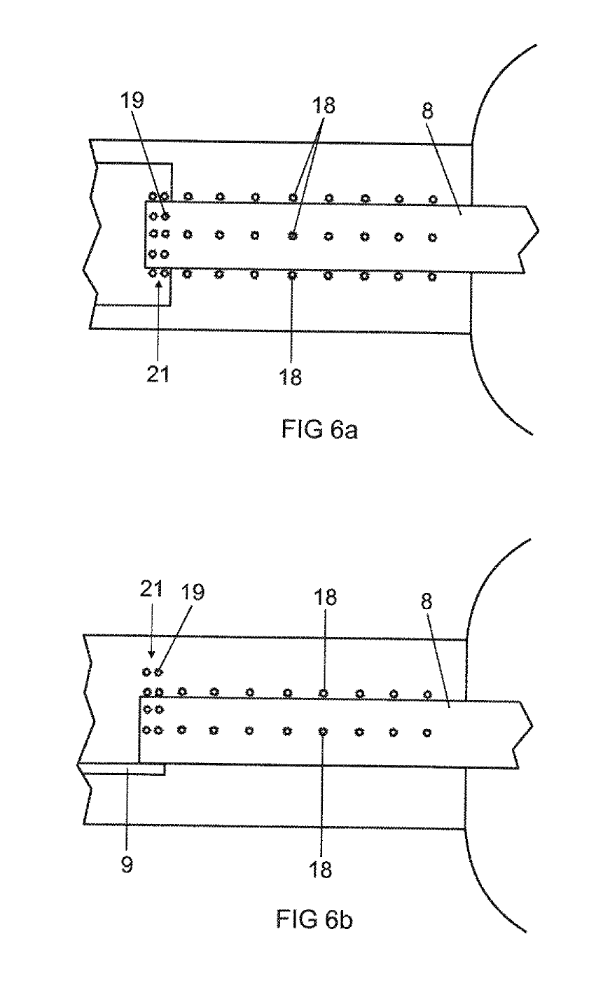

Preferred is an arrangement according to FIG. 3, where the spacing of the disruptive centers from one another and also from the internal current supply 8 is as small as possible, so that they surround part of the axial length of the internal current supply in the manner of a stocking. In this case, a uniform array of disruptive centers may be produced. However, also according to FIG. 6, individual axial lines 18 or individual radial circles or partial circles 19 may be produced around the internal current supply.

Moreover, structures 20 wound in the manner of a spiral, such as a string of beads, may also be produced and namely one or more depending on the selected “pitch” of this structure guided in a helical manner around the supply line, see FIG. 7.

According to FIG. 6, this prevention structure 21 may also be applied in the region of the point where the internal current supply is welded to the foil 9. It is applied over the end of the internal current supply in a manner similar to the shape of a half-shell. Additionally, in this case individual axial lines 18 are shown along the internal current supply.

The induced crack structure may be at a certain distance from the metal but the individual micro-cracks are still intended to have the effect of channeling the cracks produced by the glass stresses similar to a core pin coil, which do not cause a damaging effect over a larger spatial area.

The embodiment of FIG. 3, however, completely protects the metal of the internal current supply 9 in a specific region by a sealed structure of the micro-cracks and disruptive centers.

It is entirely possible to adjust the laser so that it does not alter the structure of the internal current supply. Technically, however, it is simpler to focus directly onto the embedded surface of the supply line as, even with slightly inaccurate focusing, the laser beam forms the micro-crack as a disruptive center in the glass, in the form of a microplasma/local overheating at the desired point, close above the surface of the supply line. The metal is thus hardly altered.

In this case, for example, a sharply focused Nd:YAG laser may produce such structures directly after the embedding process in the quartz glass, as soon as the quartz glass is solidified and before random cracks can be produced. As a result, it is necessary for the processing temperature T of the glass to be below Tg, in particular at least 5% below Tg, when Tg is measured in Kelvin. A preferred lower limit is 30% of Tg. In principle, namely for the laser treatment, it is possible to wait until the glass has completely cooled, but then it cannot be excluded that random micro-cracks have already formed, which would reduce the effectiveness of the treatment set forth here.

With a sufficiently dense structure of micro-cracks, the supply line, i.e. generally the internal current supply and/or the electrode pin, may be uncoupled in a precisely defined form from the surrounding quartz, and in the event of further cooling no further stresses are produced in the quartz which would compromise the product. The measure should be applied, therefore, directly during the cooling phase or shortly after.

The structure produced exhibits a uniformity in the crack structure and the shape of the micro-cracks. These differ visibly from random cracks. Each individual micro-crack is very small and is likely to start radially from a point (understood as the focus of the laser or disruptive center) the stress crack 29 to be relieved, however, is a separate large crack.

In contrast thereto, FIG. 4 shows uncontrolled stress relief cracks 30 without any kind of prevention structure.

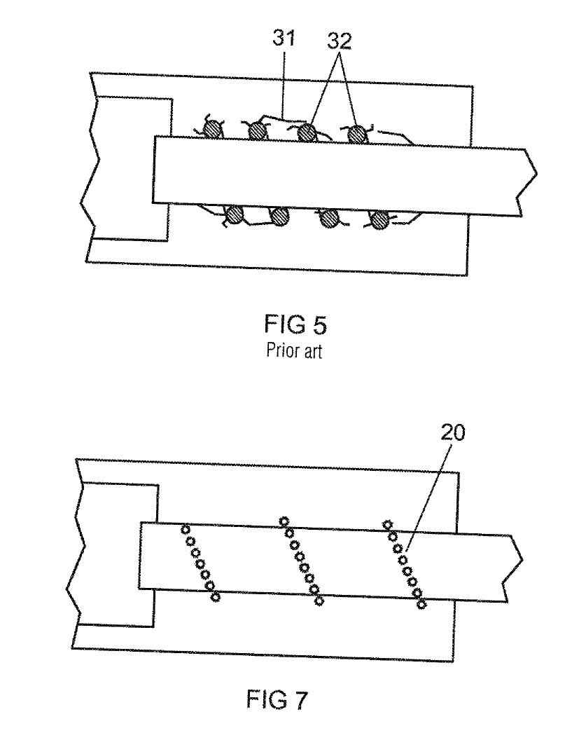

FIG. 5 shows the stress relief cracks 31 which are formed when a filament 32 is used as a prevention structure, as known per se.

It should be clarified again that both a filament and the gas between two electrodes are considered as illumination means.

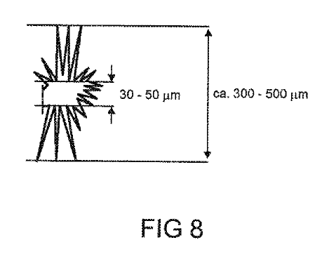

FIG. 8 shows the detailed image of a micro-crack specifically generated in mass-production. It is reminiscent of a three-dimensional Christmas star cut in an irregular manner.

The spacing of the micro cracks from one another does not have to be uniform, in particular it is able to fluctuate within a tolerance range.

In particular, the micro cracks are spaced apart from the supply line at a maximum of 30% of the covering glass thickness or alternatively a maximum of 100 μm. Moreover, preferably the diameter of a micro-crack in the glass, to be regarded as a disruptive center, is a maximum of 25% of the covering glass thickness or alternatively a maximum of 200 μm.

Essential features of the invention in the form of a numbered list are:

1. An electrical lamp having a bulb made of glass which surrounds a volume, illumination means extending into the volume and a filling, which in particular contains metal halides, being accommodated in the volume, the illumination means being fastened at least by means of a supply line in the wall of the bulb and being sealed there, characterized in that at least one part of the axial length of the supply line is surrounded inside the wall by a prevention structure, which is present in the glass itself.
2. The electrical lamp as claimed in claim 1, characterized in that the prevention structures are micro-cracks specifically incorporated in the glass.
3. The electrical lamp as claimed in claim 2, characterized in that the micro-cracks are arranged uniformly spaced apart one behind the other in an axial manner.
4. The electrical lamp as claimed in claim 2, characterized in that the micro-cracks are arranged uniformly spaced apart in a radial manner around the supply line.
5. The electrical lamp as claimed in claim 2, characterized in that the micro-cracks are uniformly spaced apart in the manner of a sleeve in the radial and axial direction around the supply line.
6. The electrical lamp as claimed in claim 2, characterized in that the micro-cracks are spaced apart from the supply line at a maximum of 30% of the covering glass thickness or alternatively a maximum of 100 μm.
7. The electrical lamp as claimed in claim 2, characterized in that the diameter of a micro-crack in the glass, to be interpreted as a disruptive center, is a maximum of 25% of the covering glass thickness or alternatively a maximum of 200 μm.
8. A method for producing a prevention structure in an electrical lamp as claimed in claim 1, characterized in that after heating and sealing the bulb a cooling of the sealing region which contains the supply line to a temperature of less than Tg of the glass is awaited and subsequently the surrounding region of at least one part of the supply line is provided with a prevention structure, by a suitably focused laser being oriented toward this surrounding region.

1. An electrical lamp, comprising:
a bulb made of glass which surrounds a volume;
illumination means extending into the volume and a filling, being accommodated in the volume;
the illumination means being fastened at least by means of a supply line in the wall of the bulb and being sealed there;
wherein at least one part of the axial length of the supply line is surrounded inside the wall by a prevention structure, which is present in the glass itself.

2. The electrical lamp as claimed in claim 1, wherein the prevention structures are micro-cracks specifically incorporated in the glass.

3. The electrical lamp as claimed in claim 2, wherein the micro-cracks are arranged uniformly spaced apart one behind the other in an axial manner.

4. The electrical lamp as claimed in claim 2, wherein the micro-cracks are arranged uniformly spaced apart in a radial manner around the supply line.

5. The electrical lamp as claimed in claim 2, wherein the micro-cracks are uniformly spaced apart in the manner of a sleeve in the radial and axial direction around the supply line.

6. The electrical lamp as claimed in claim 2, wherein the micro-cracks are spaced apart from the supply line at a maximum of 30% of the covering glass thickness or alternatively a maximum of 100 μm.

7. The electrical lamp as claimed in claim 2, wherein the diameter of a micro-crack in the glass, to be interpreted as a disruptive center, is a maximum of 25% of the covering glass thickness or alternatively a maximum of 200 μm.

8. A method for producing a prevention structure in an electrical lamp, the electrical lamp comprising:
a bulb made of glass which surrounds a volume;
illumination means extending into the volume and a filling being accommodated in the volume;
the illumination means being fastened at least by means of a supply line in the wall of the bulb and being sealed there;
wherein at least one part of the axial length of the supply line is surrounded inside the wall by a prevention structure, which is present in the glass itself;
the method comprising:
after heating and sealing the bulb, providing a cooling of the sealing region which contains the supply line to a temperature of less than Tg of the glass is awaited and subsequently the surrounding region of at least one part of the supply line with a prevention structure, by a suitably focused laser being oriented toward this surrounding region.

9. The electrical lamp as claimed in claim 1,
wherein the filling contains metal halides.
